(19) United States
(12) Patent Application Publication
(10) Pub. No.: US 2003/0101602 A1
(43) Pub. Date: Jun. 5, 2003

(54) Measurement of geometric parameters of internal and external screw thread and similar grooves

(76) Inventor: Reginald Galestien, Oosterhesselen (NL)

Correspondence Address: Kinney & Lange, The Kinney & Lange Building, 312 South Third Street, Minneapolis, MN, 55415-1002, US

(21) Appl. No.: 10/181,091

(22) PCT Filed: Jan. 12, 2001
(86) PCT No.: PCT/NL01/00017

(51) Int. Cl. G01B 3/40

(52) U.S. Cl. 33/199 R

(57) ABSTRACT

A method for determining a geometric parameter of an axial cross section of internal or external screw thread, comprising, with at least one probe, mechanically probing in radial direction two screw thread profiles of the screw thread to be measured, at two probing positions which are located diametrically opposite each other and which are both situated in a plane through a centerline of the screw thread, measuring a distance in said plane through the centerline of the screw thread in radial direction with respect to the screw thread between the probes in probing position, while the at least one probe is a wedge probe, the method further comprising the setting of a probing width of the at least one wedge probe, determining the geometric parameter on the basis of the measured distance between the probes in probing positions and a pitch of the screw thread.

This invention relates to the measurement of screw thread profiles of internal and external screw thread and similar grooves, for determining geometric parameters of the screw thread.

An important geometric parameter of screw thread is the flank diameter. The flank diameter is the diameter of an imaginary cylinder whose centerline coincides with the centerline of the screw thread and whose circumferential surface intersects the screw thread in a manner such that there is a balance between material and air; according to most definitions of screw thread standards, this balance is 50% air, 50% material.

Besides the definition of the fank diameter, alternatively the definition of the simple flank diameter is often used in screw thread technique: the simple flank diameter is the diameter of an imaginary cylinder coaxial with respect to the screw thread and of which any circumferential surface line intersects the screw thread profile such that the segment formed by the screw thread groove has a length equal to half of the nominal pitch.

Measurement of the flank diameter with traditional means depends on various parameters which in practice are difficult to measure and hence are often not measured and whose value is taken to be equal to nominal. However, this gives rise to an uncertainty of measuring results that is not adequate for the application in question.

So, the traditional screw thread measuring technique is an indirect measuring technique whereby the measuring result of the flank diameter is bared on a number of assumptions. It is often assumed that the value of the pitch, the left-hand flank angle, the right-hand flank angle and the shape of the profile correspond with the theoretically ideal nominal values.

There are methods known for high-precision calibration of screw thread calibers; however, these require complex measuring instruments and a strictly controlled measuring environment and are therefore in practice unusable for measuring screw thread products. For workshop use, there are known: the three-wire method, the twin-ball method, rim and cone method, use of profile probes and profile rollers.

The definition of flank diameter such as it is utilized in virtually all screw thread standards, starts from the diameter where the width of the groove is equal to the width of the top. This diameter is therefore situated at the half-height of the sharp screw thread profile.

The measuring uncertainty of all known workshop measuring methods of the flank diameter is disputable, in particular due to the influence of the flank angles, pitch and the profile purity of the flanks.

Known is the three-wire method such as described, for instance, in U.S. Pat. No. 4,480,388. A disadvantage of the three-wire method is that a large number of measuring wire diameters and intermediate standards are needed to enable measurement of the most common kinds, such as Metric, Whitworth and Unified screw threads.

The determination of the flank diameter using the three-wire measuring method is strongly dependent on the correct values of the partial flank angles and the pitch. It will be difficult to measure the partial flank angles while the workpiece is still fixed on the working machine. In addition, the three-wire method can be used exclusively for external screw thread. For the internal screw threads, as an alternative to the three-wire method, the twin-ball method is deployed, such as described, for instance, in GB 556,343, which has the same disadvantages as the three-wire method.

Also known is a three-ball method according to U.S. Pat. No. 4,202,109, which has the same disadvantages as the twin-ball and three-wire method.

Known, further, are measuring methods which utilize rim and cone probes or measuring jaws and measuring rollers. Also known are methods based on profile probes as described in U.S. Pat. No. 4,611,404.

The influence of angular deviations on the flanks makes it impossible to accurately determine the flank diameter in accordance with the definition from the standards.

From investigations with equipment in conformity with EP 0932017 A1, EP 982019064.7 and EP 99200183.4, it is known that these partial flank angles can open deviate strongly from the nominal values, whereas the pitch mostly corresponds very well with the nominal values.

Another disadvantage of the known methods for measuring the flank diameter is that different probes are required for each value of the pitch or of the partial flank angles.

For Metric, Whitworth and Unified screw thread, dozens of different pairs of probes are necessary. In addition, the known methods have the disadvantage that the measuring values are correlated to complexly shaped standards. Of these, too, therefore, dozens are needed to enable measurement of the most common screw threads. The use of the rim and cone method is moreover limited to external screw thread.

From the German patent specification 377 547, a method for measuring the flank diameter of an external screw thread is known which utilizes a thread gauge in which on a first jaw of the thread gauge a block with a slot is fitted and on the second jaw of the thread gauge a cylinder is fitted. The width of the slot corresponds accurately with the diameter of the cylinder. However, a disadvantage of this method is that it can only be used for symmetrical screw thread, and that for measuring various screw threads a multiplicity of measuring tools are needed.

Moreover, there will be probing engagement of the flank cylinder only in the case where the width of the slot is equal to half of the pitch. For screw thread having other pitch dimensions, there will be no probing engagement of the flank cylinder, so that any profile deviation has an influence on the measuring value.

Accordingly, there is a need for a method for determining geometric parameters such as the flank diameter and the simple flank diameter of both internal and external screw thread for the most diverging screw thread systems and screw thread dimensions, and which is less sensitive to the values of the partial flank angles and which can be used rapidly, inexpensively and in situ with a measuring uncertainty desired or the purpose, without necessitating complex setting standards or complex computations.

The object of the invention is to provide an improved method for determining geometric parameters of screw thread. To that end, the invention provides a method according to claim 1.

According to the invention, a wedge probe is used, whose probing width is set. Thereafter the geometric parameter is determined on the basis of the measured distance between the probes in probing position and a pitch of the screw thread. The probing positions are here situated diametrically opposite each other and are both situated in a plane through a centerline of the screw thread. What is accomplished by the setting of the probing width is that the measurement can be carried out in a simple and accurate manner on different screw threads.

By determining, in addition to the distance between the measuring positions in the measuring plane in radial sense, the displacement between the measuring positions in axial sense (in effect, a two-dimensional measurement is thus performed), it is possible to determine, in addition to, for instance, the flank diameter and the simple flank diameter, other parameters, such as, for instance, the pitch and the partial flank angles.

The invention further relates to a measuring device, suitable in particular for use with the method according to the invention, as well as to a probing element. Advantageous embodiments of the invention are described in the dependent claims.

In the following, the invention will be further elucidated on the basis of several exemplary embodiments, with reference to the accompanying drawings. In the drawings:

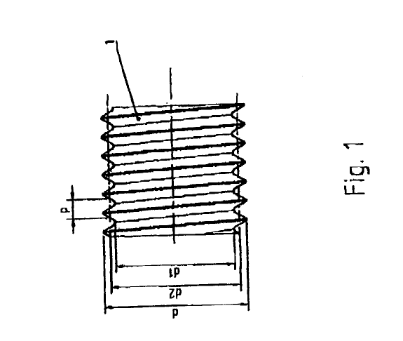

FIG. 1 schematically shows in longitudinal cross section an example of a workpiece provided with an external screw thread;

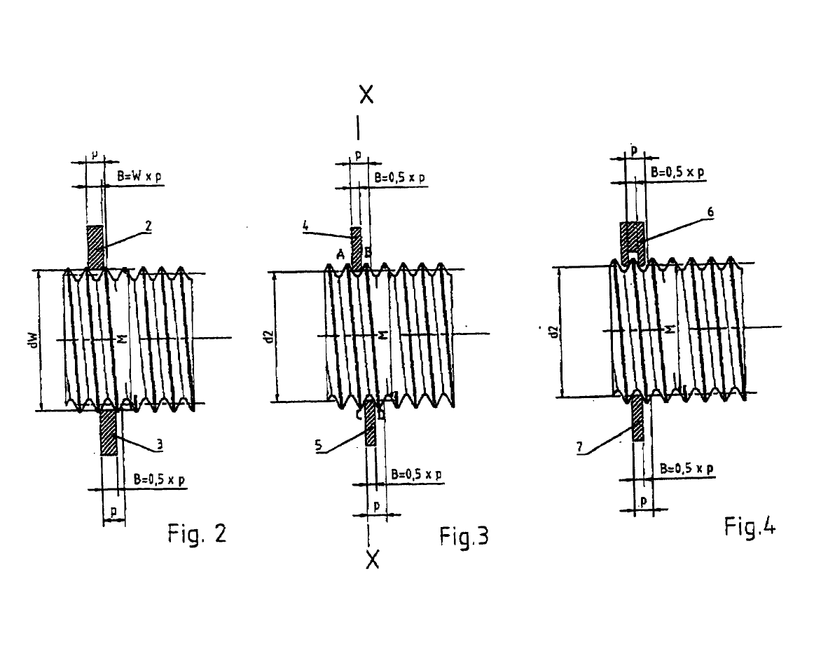

FIG. 2 schematically shows an example of a method according to the invention;

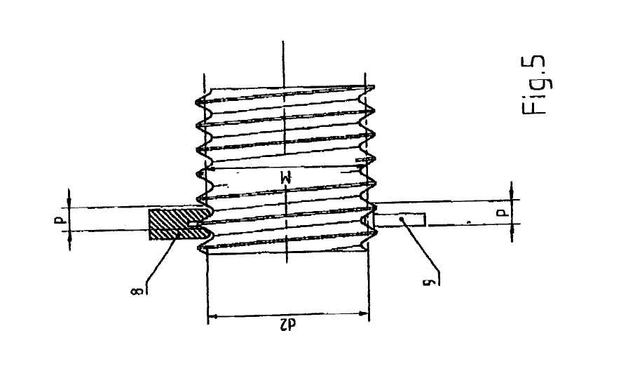

FIG. 3 schematically shows a variant of the method in FIG. 2;

FIG. 4 schematically shows a variant of the method in FIGS. 2 and 3;

FIG. 5 schematically illustrates the known procedure of the rim and cone method;

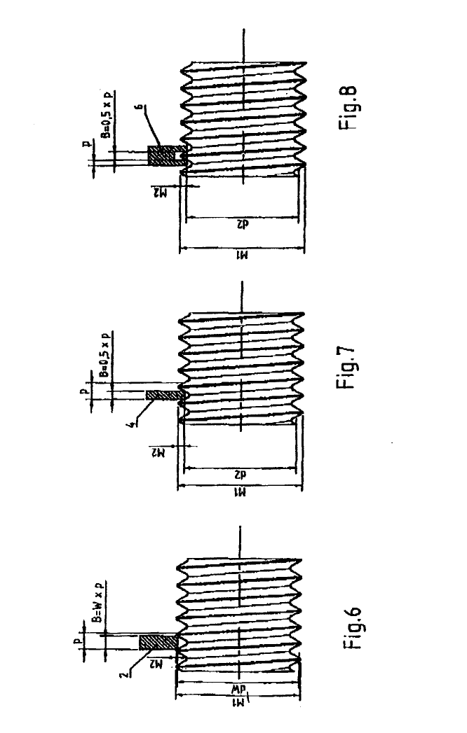

FIG. 6 schematically shows an example of a method according to the invention on the basis of sequential profile depth measurement;

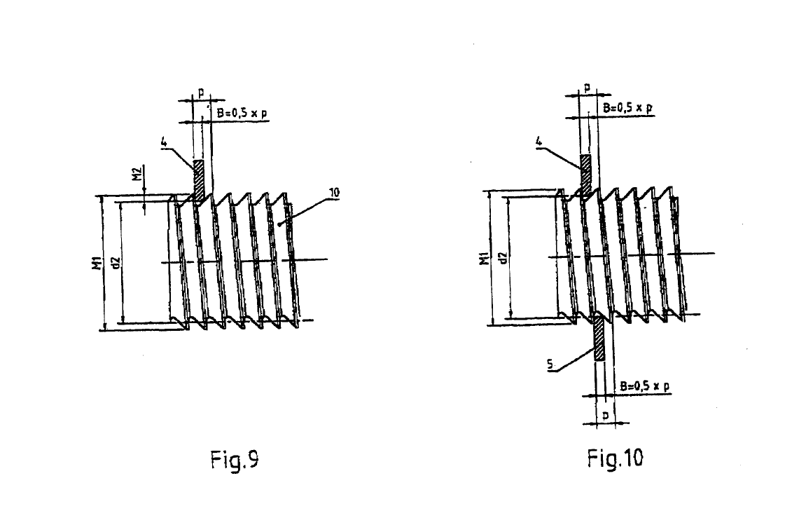

FIG. 7 schematically shows an example of a method according to the invention on the basis of sequential profile depth measurement with wedge probe;

FIG. 8 schematically shows an example of a method according to the invention;

FIGS. 9 and 10 schematically show an example of the method according to the invention for determining the simple flank diameter of strongly asymmetrical screw thread;

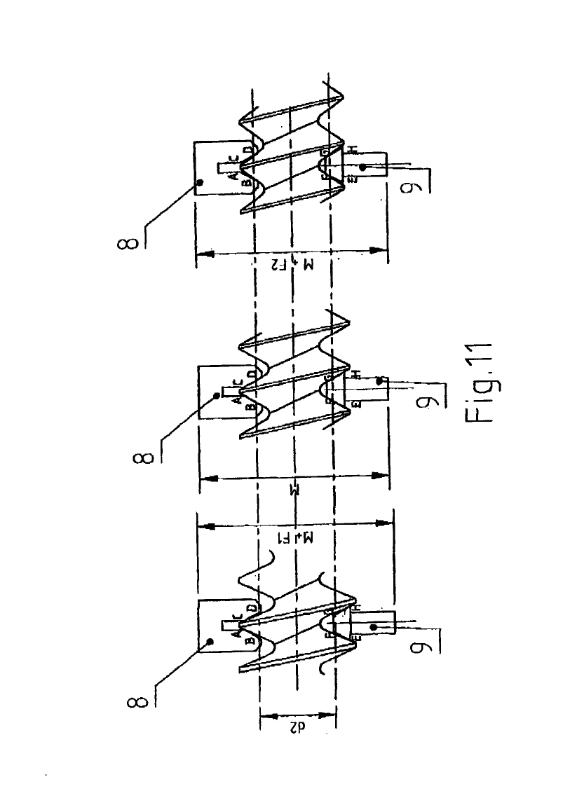

FIG. 11 schematically shows the known rim and cone method;

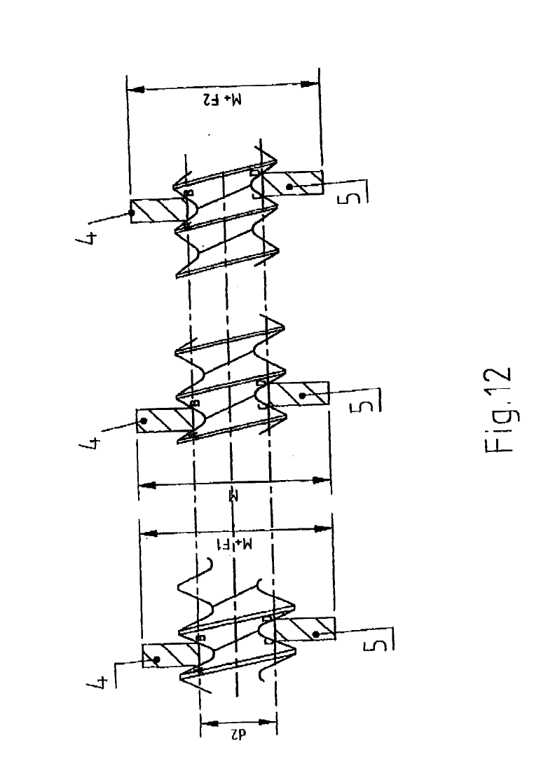

FIG. 12 schematically shows a method according to the invention;

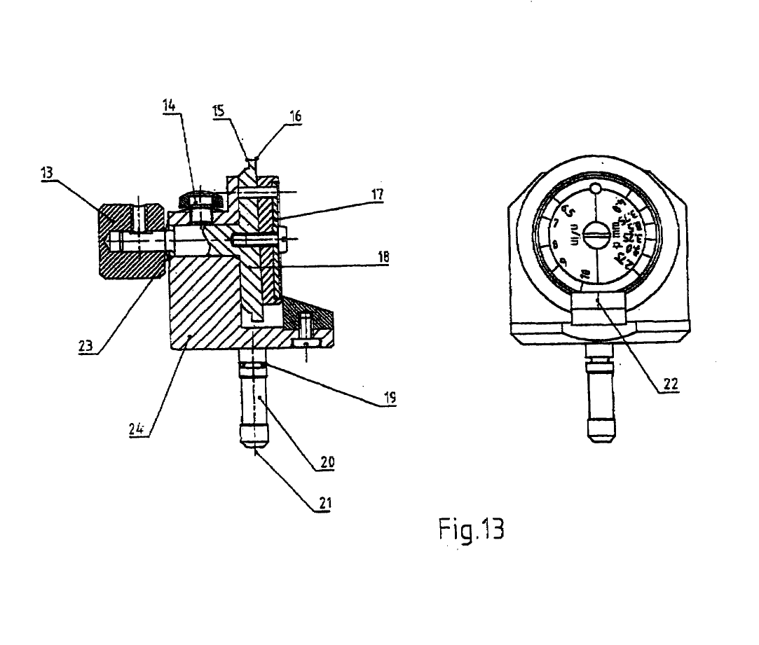

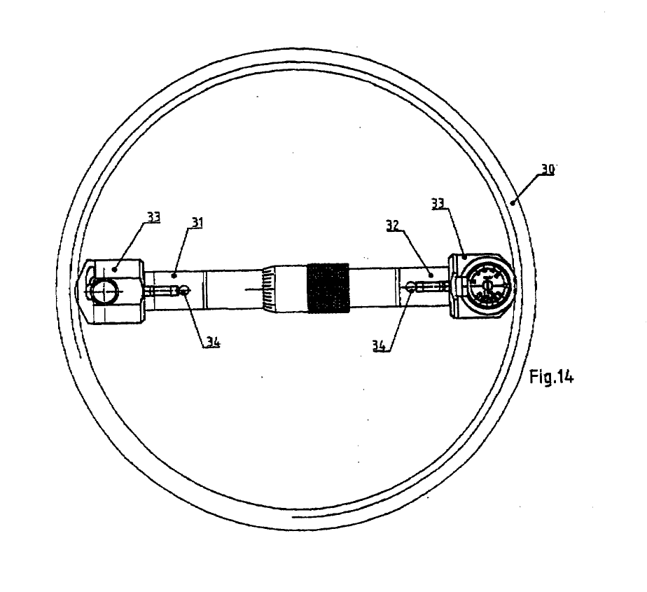

FIG. 13 schematically shows a cross section and an elevation of a wedge probe of variable wedge width according to the invention;

FIG. 14 schematically shows a measuring device according to the invention for measuring internal screw thread;

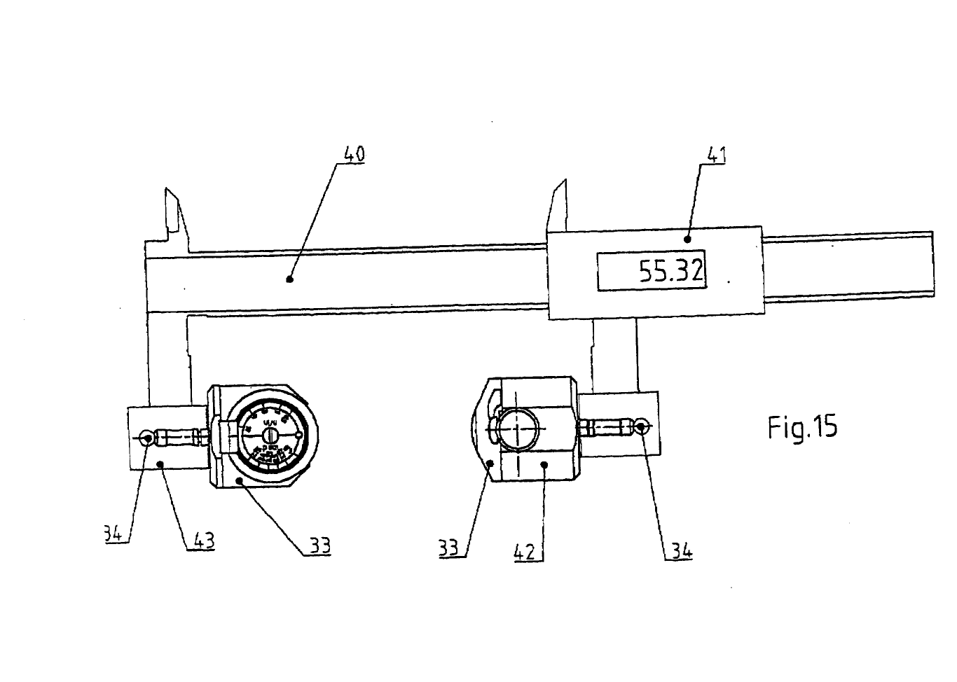

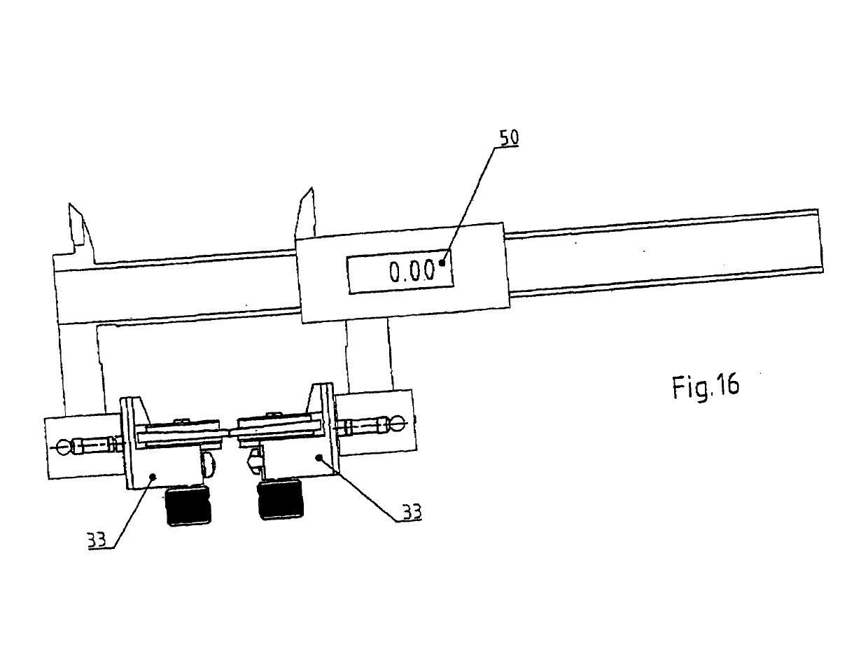

FIG. 15 schematically shows a measuring device according to the invention for measuring external screw thread;

FIG. 16 schematically shows the determination of the zero point of a measuring device according to FIG. 15;

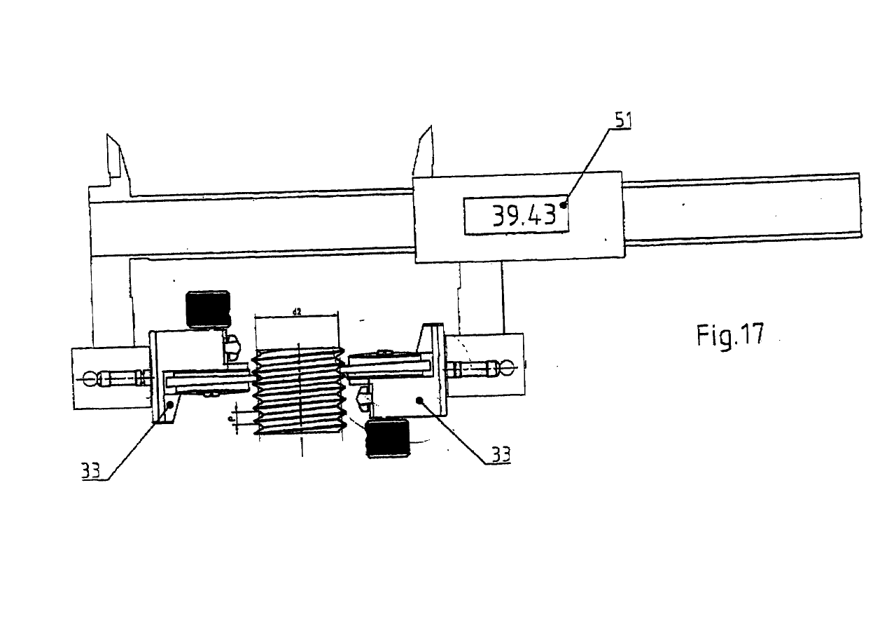

FIG. 17 schematically shows the measurement of an external screw thread with a measuring device according to FIG. 15;

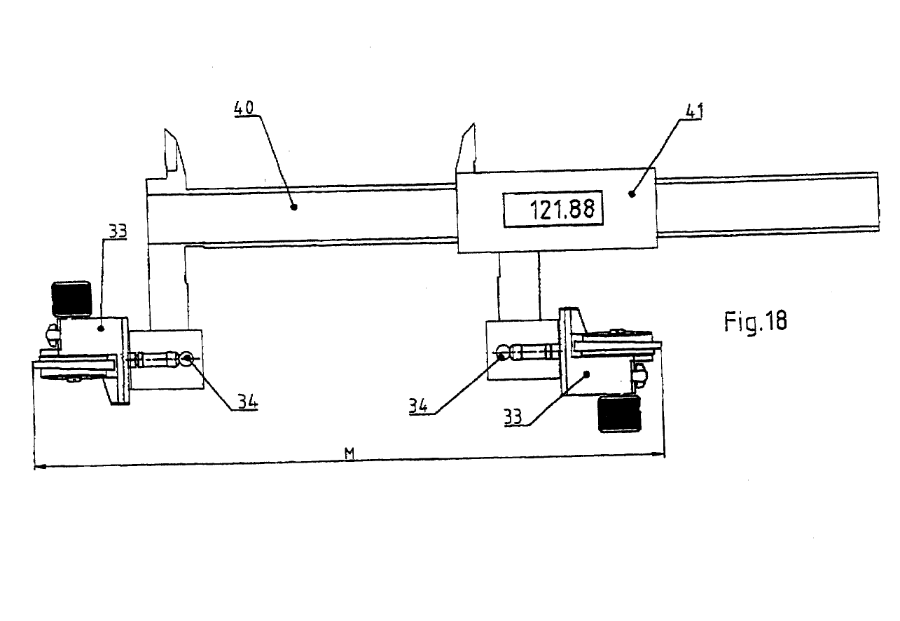

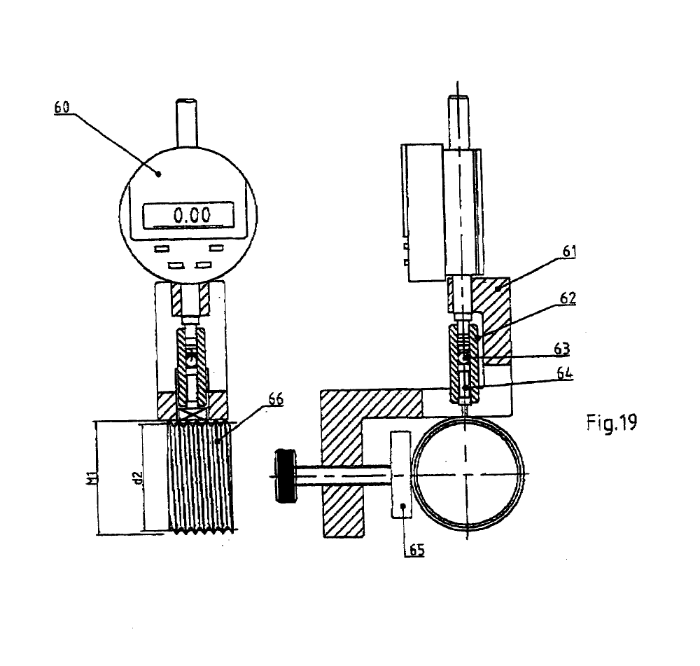

FIG. 18 schematically shows an example of a measuring device according to the invention for measuring internal screw thread;

FIG. 19 schematically shows in elevation and partial cross section a measuring device according to the invention for measuring external screw thread;

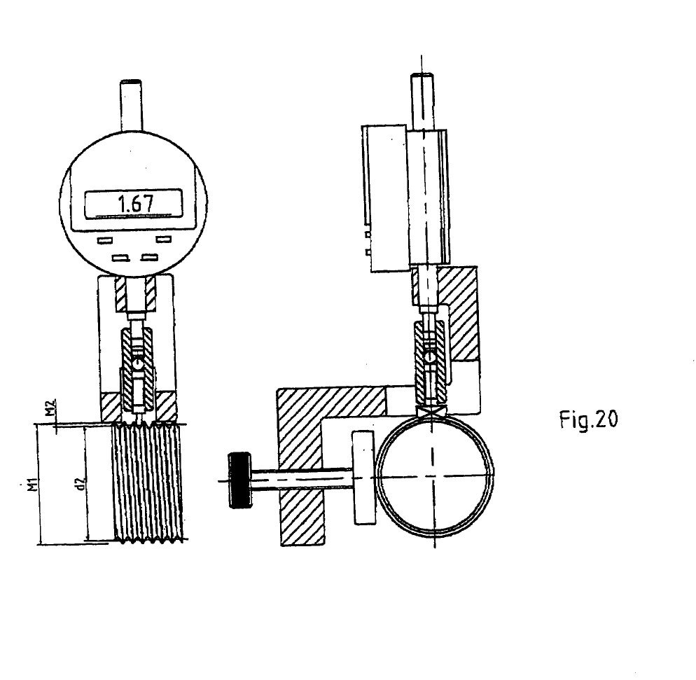

FIG. 20 schematically shows in elevation and partial cross section a measuring device according to FIG. 19, with the wedge probe being supported in the profile for determining the profile depth;

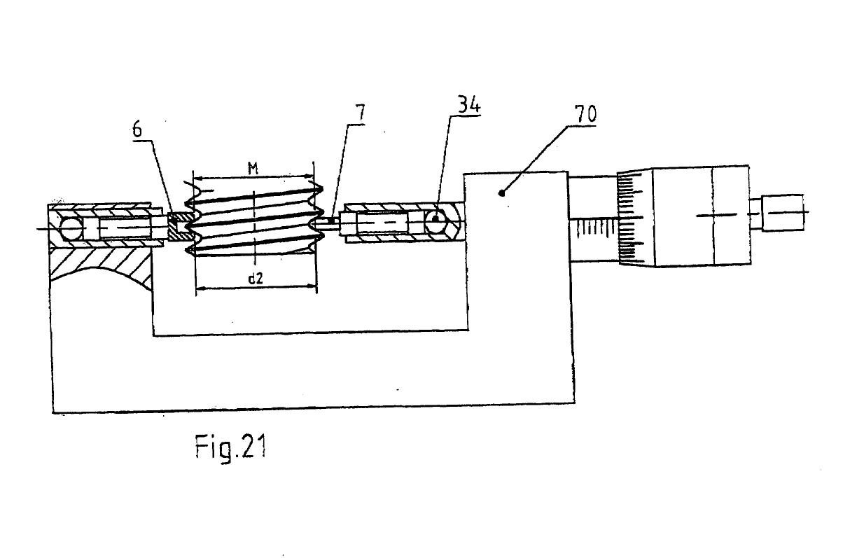

FIG. 21 schematically shows by way of example the partial cross section of a measuring device according to the invention for measuring external screw thread;

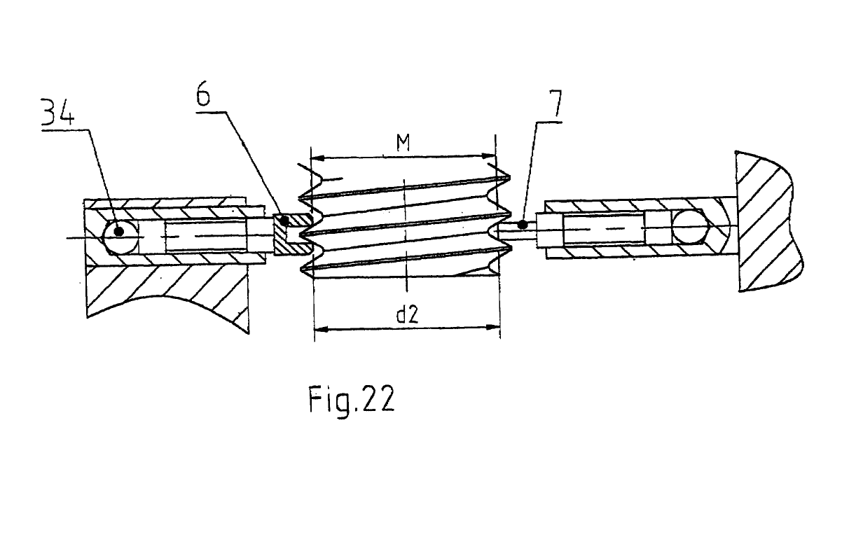

FIG. 22 shows a detail of FIG. 21;

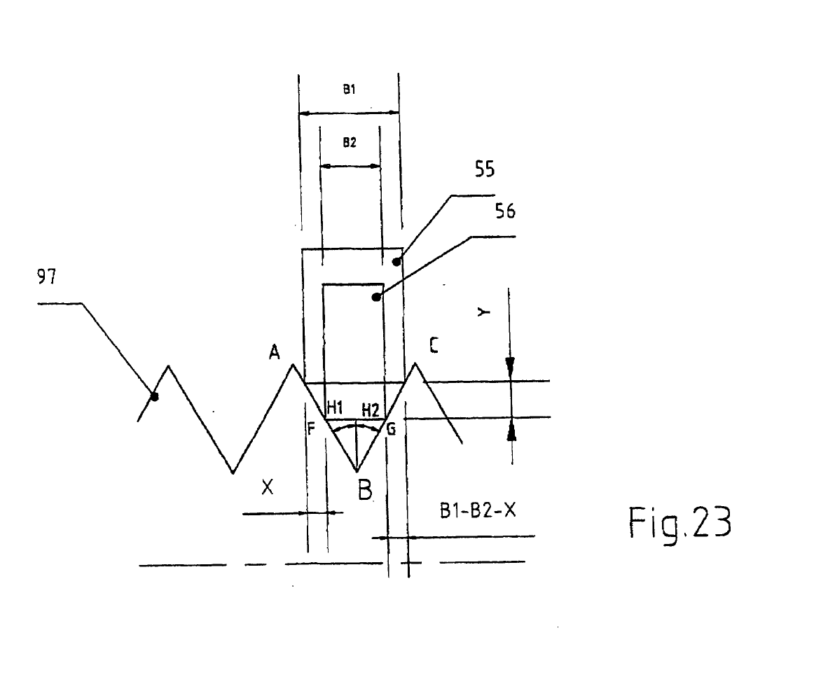

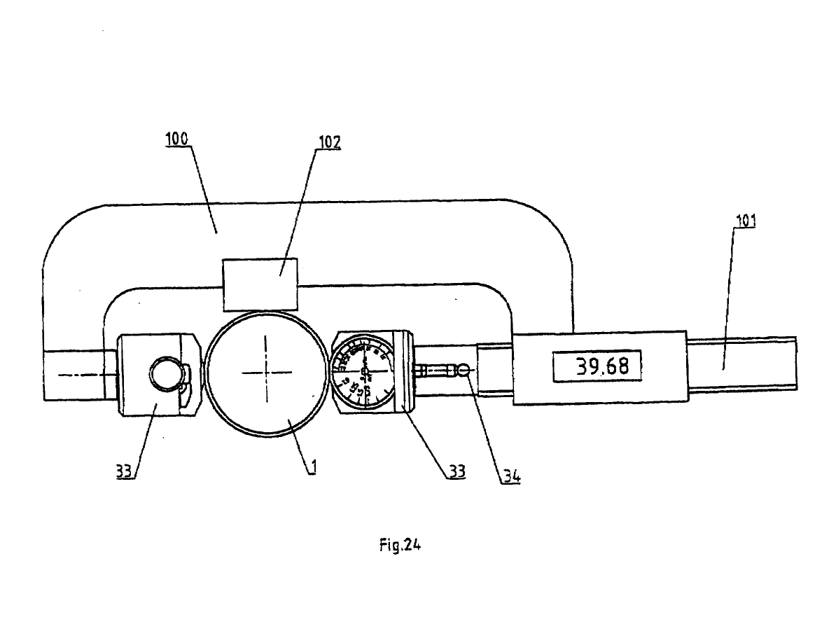

FIG. 23 schematically shows the method according to the invention for determining a left-hand and right-hand partial flank angle of a screw thread profile;

FIG. 24 schematically shows an example of a measuring device according to the invention for measuring external screw thread;

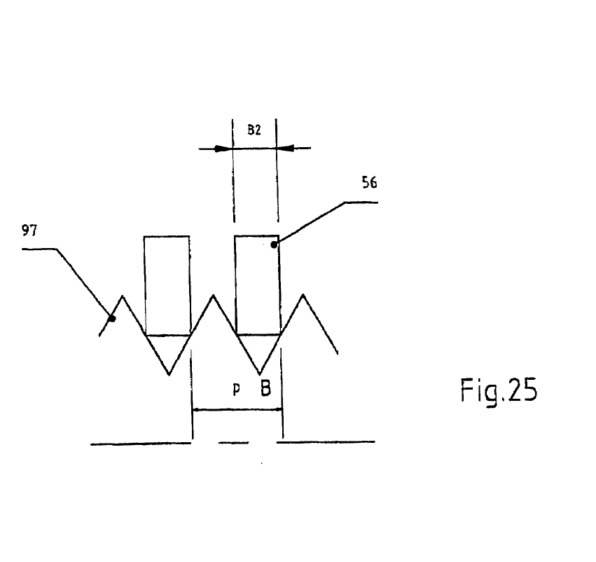

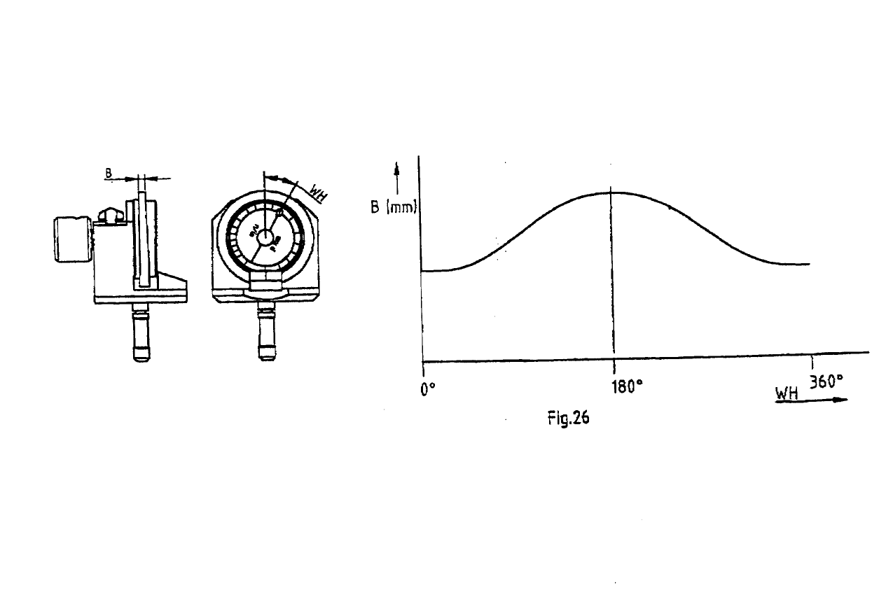

FIG. 25 schematically shows the method according to the invention for determining the pitch p of a screw thread profile;

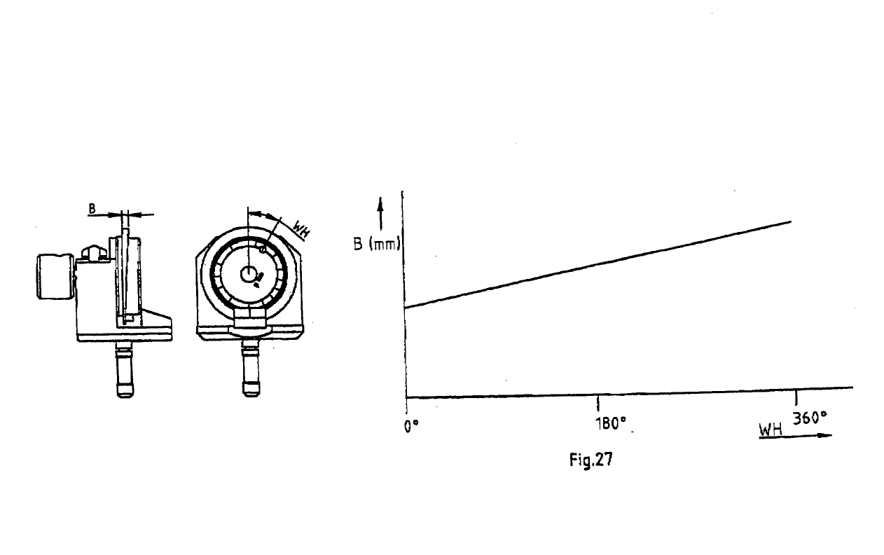

FIG. 26 schematically shows, as an example according to the invention, a wedge probe of variable wedge width;

FIG. 27 schematically shows, as an example according to the invention, a wedge probe of variable wedge width,

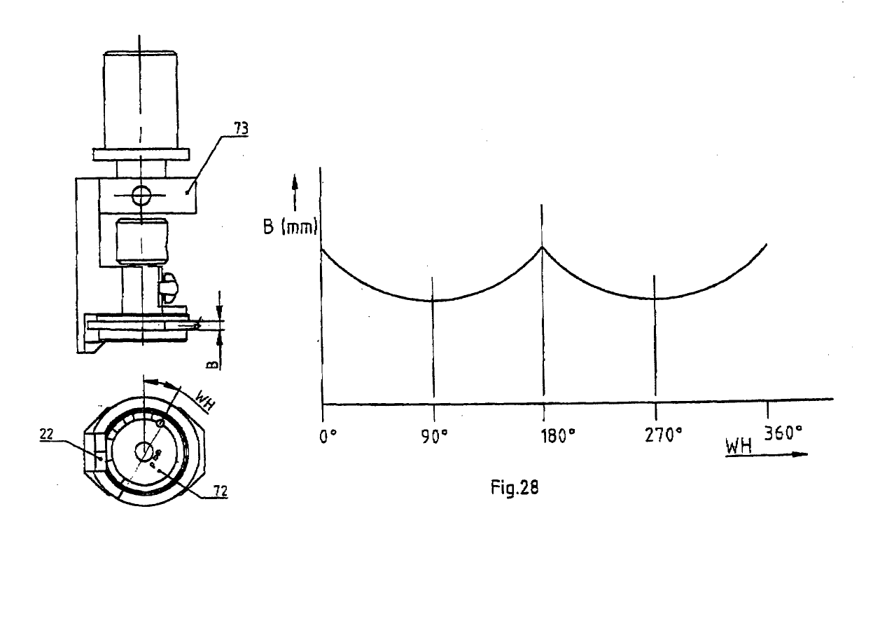

FIG. 28 schematically shows, as an example according to the invention, a variable wedge probe with mount for a coordinate measuring machine or height gauge;

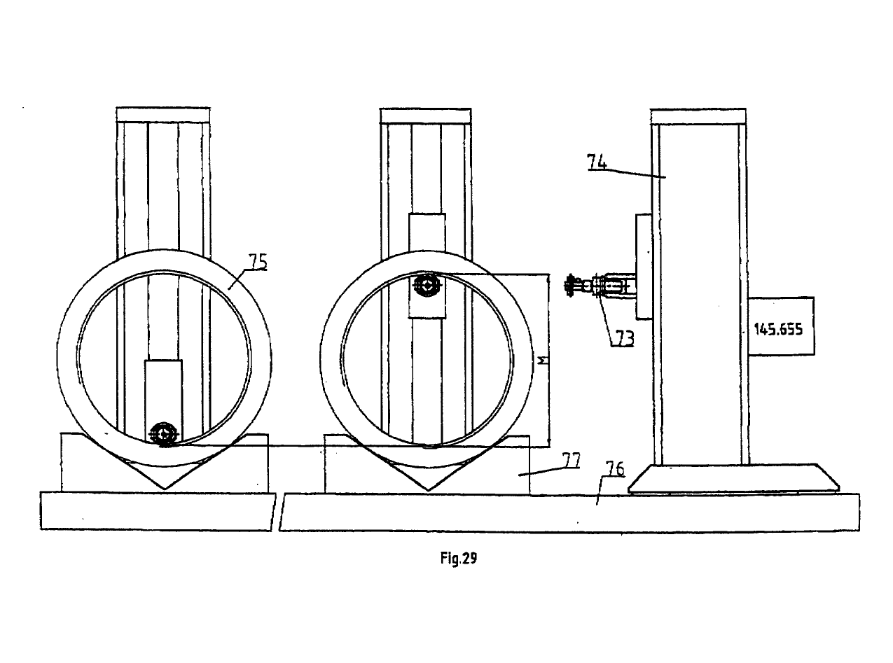

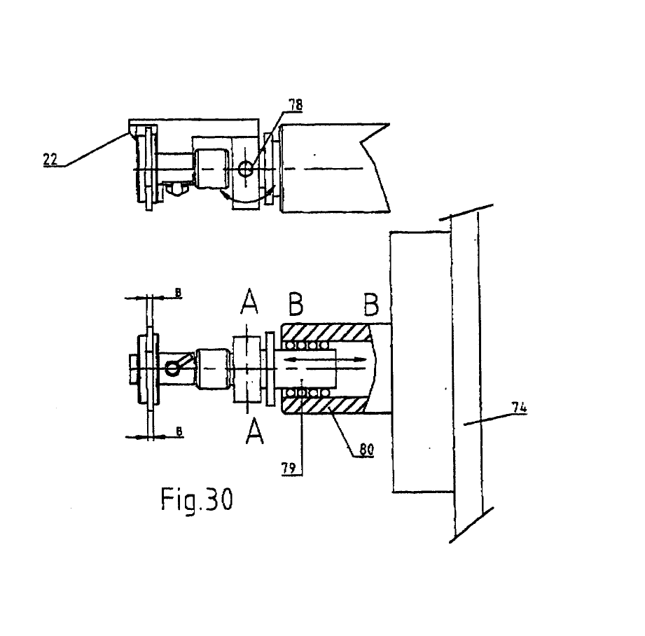

FIGS. 29 and 30 schematically show an example of a measuring device according to the invention for measuring screw thread with a wedge probe according to FIG. 28; and

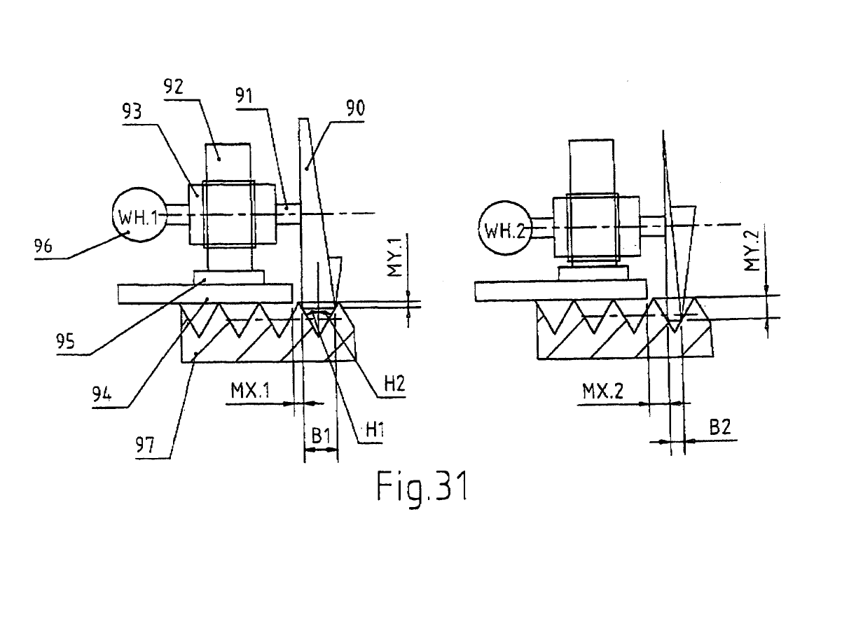

FIG. 31 schematically shows an example according to the invention of a measuring device for determining the left-hand and right-hand flank angle.

The invention provides a method for determining one or more geometric parameters of screw thread, characterized in that simultaneously (see FIGS. 2, 3 and 4) or sequentially (see FIGS. 6, 7 and 8) two screw thread profiles situated diametrically opposite each other and both located in a plane through the centerline of the screw thread, are probed mechanically in radial direction by the two measuring sides of wedge probes, which are shaped such that the sharp measuring sides have contact points on the screw thread flanks which are situated as closely as possible in the proximity of the axial plane through the centerline of the screw thread and which, at the points of contact with the flanks, have an accurately known fixed or variable mutual distance, i.e., wedge width, and which, at the points of contact with the flanks, are situated in or tangent to a geometric plane which is parallel to the reference axis of the screw thread, whereafter the radial component of the distance between the corresponding measuring sides in the two above-mentioned wedge probe positions is determined through a direct measurement in the case of simultaneous wedge probe probing or, in the case of a sequential wedge probe probing, through a linked measurement of the profile depth measurements of the wedge probes with the measurement of a suitable intermediate parameter as the outside diameter in the case of external thread or the core diameter in the case of internal thread. ‘Linked measurement’ is understood to mean that through an arithmetical computation, via an intermediate result, an end result is obtained.

FIGS. 9 and 10 schematically illustrate an example of the method according to the invention for determining the simple flank diameter of strongly asymmetrical screw thread 10 with wedge probes 4 and/or 5 having a wedge probe width B which is equal to half the pitch.

FIG. 12 schematically illustrates the insensitivity of the method according to the invention to variations of the partial flank angles through the comparison of the same three screw threads from FIG. 11, which all have the same diameter d2 but each have a different flank angle, which is greater than, equal to and less than the nominal flank angle: each situation results in the same measuring value M.

In addition to the use of wedge probes of a fixed wedge width as at 64 in FIG. 19 and 6 and 7 in FIG. 21, the invention provides the use of a wedge probe of variably adjustable wedge width.

By changing the distance between the two measuring sides of a wedge probe at the contact points on the screw thread flanks between a particular minimum value Bmin and maximum value Bmax, it is possible to measure the flank diameter of screw threads of a pitch between 2×Bmin and 2×Bmax without necessitating any exchange of the wedge probes. The variation of the wedge width can occur in any manner suitable for the purpose. In the following, by way of example, for the method of the invention, an example of such a wedge probe of variably adjustable wedge width is elucidated with reference to FIG. 13. The wedge probe element 18, which is manufactured from hard wear-resistant material, has two sharp measuring sides 15 and 16 at the contact points on the screw thread profile and can be rotated in the main bore of the probe housing 24 about the axis 24 by means of the knob 13. The rotation of the wedge element can be locked by means of a clamping screw 14.

The wedge probe element is formed by a right circular cylinder, which is properly concentric with respect to the rotation axis, while the left-hand side of the wedge element is shaped such that the measuring side 15 in each rotational position is situated in a plane through the centerline 21 of the mounting pivot 20. A spring ring 23 prevents the occurrence of axial play between the probe housing and the wedge element, as a result of which the measuring side would leave the plane referred to, which could adversely affect the measuring uncertainty in the ease of simultaneous measurements. This is clarified in FIG. 17. For the correct diameter measurement of the screw thread, the linear measuring element should be perpendicular to the centerline of the screw thread to be measured, with the two wedge probes rotated relative to each other about their centerline 21 as a result of the pitch angle of the screw thread.

Due to the centerlines 21 of the two wedge probes 33 in FIG. 17 being in one line and the two measuring sides 15 being situated in the centerline 21 of the mounting pivot 20, this condition is met.

The distance between the measuring sides 15 and 16 at the contact points on the screw thread profile, i.e. the wedge width B, can be set according to a characteristic, as presented in FIG. 26 or 27, through the associated setting angle WH. On the basis of this wedge width/wedge angle characteristic, it is possible to provide a scale division 17 on the wedge element, which makes it possible to set the proper wedge width in millimeters and/or threads per inch with respect to the index mark 22.

The invention further relates to some measuring devices and accessories for measuring devices which are based on the application of the method for measuring internal and/or external screw threads with wedge probes.

To that end, according to the invention, linear measuring systems, such as, for instance, a sliding gauge (FIGS. 15, 16, 17 and 18), thread gauge (FIGS. 14, 21 and 22) or universal single-axial measuring machine, are provided with mounts for two wedge probes 6 and 7 of a fixed wedge width or two wedge probes 33 of variably adjustable wedge width for simultaneously probing two diametrically opposite screw thread profiles.

These probe mounts 42 and 43 in FIG. 15 are provided with bores whose centerlines are as best as possible in line with each other and are parallel to the measuring direction of the linear measuring system and which are mechanically connected in a robust manner wit the fixed 40 and moving part 41 of the linear measuring system.

In each bore, a wedge probe 33 can be fitted, by the mounting pivot thereof, which can rotate in the mounting bore with little resistance and little axial clearance for the probe to be able to properly orient itself in the direction of the thread to be measured.

It is of importance that any axial travel of the wedge probe be small because during the measurements the wedge probes must be able to freely orient towards the direction of the groove to be measured without the measuring value being influenced by any axial movement of the wedge probe in its mount as a result of this axial stroke. The axial stroke can be minimized, for instance, by placing a spherical ball 34 at the bottom in the center of the mounting bore, by minimizing the clearance between the bore and the probe mounting pivot and finishing the contact surface with which the probe mounting pivot is supported against the ball such that the contact surface is planar and perpendicular with respect to the centerline.

The probe falling unintentionally out of the mount is prevented by the use of, for instance, an element such as a wire spring ring 19 in a groove, which is inserted in the mounting pivot 20 of the wedge probe, as a result of which friction arises in axial direction, which prevents the probe falling out and possibly being damaged, but not in tangential direction of the probe mounting pivot, which is of benefit to the measuring uncertainty.

By splitting the simultaneous measurement into sequential wedge probe measurements with supplemental diameter linked measurements such as the outside diameter in the case of external screw thread with for instance a sliding gauge or external thread gauge (see FIGS. 6 and 7) and the core diameter in the case of internal screw thread with a sliding gauge or an internal thread gauge, the wedge probe measuring equipment can be made still simpler and more compact.

FIG. 19 schematically shows, by way of example, in elevation and partial cross section, a measuring device according to the invention for measuring external screw thread, consisting of a support 61 with a centering aid 65, a clock gauge 60 with an analog or electronic measuring system, and a wedge probe 64 in a holder 62 for sequentially probing the external screw thread, with the wedge probe rotated through 90° to be supported on the outside diameter for the zero point determination.

FIG. 20 schematically shows, in elevation and partial cross section, a measuring device according to FIG. 19, wherein the wedge probe 64 is supported in the profile to determine the profile depth. The axial stroke of the wedge probe 64 in the holder 62 is limited by the intermediate ball 68. This device is suitable in particular for cutting screw thread to the proper depth in a shaftlike product on a lathe.

A particular variant of the sequential measurement is the application of a wedge probe, to be used on two sides, of the fixed or variably adjustable type, in combination with a height gauge on a flat plate or with a coordinate measuring machine.

In FIGS. 29 and 30 the combination of a height gauge 74 with a wedge probe of the variable type 73 is represented schematically. The height gauge is displaceable over the flat plate 76 to enable a proper probing of the workpiece 75 supported by the V-block 77 at the lower and upper point of reversal.

To be able to probe in these two probing positions with the same wedge width in a single fixation of the probe, a wedge width/setting angle characteristic and mechanical construction are necessary such as, for instance, schematically indicated in FIG. 28.

The wedge width is repeated upon a rotation of the wedge element of 180°, while the pitch of the thread to be measured can be set by means of the scale division 72 and the index mark 22. The probe housing 73 is so constructed that the wedge element is accessible both from above and from below for probing, and that the probe can be locked only in one orientation with respect to the measuring direction of the height gauge.

From the point of view of ease of operation, the mount of the wedge probe can be provided with a rotary pivot A-A, which is free of clearance and axial stroke, so that the wedge in the two probing positions can orient towards the direction of the thread without requiring the whole height gauge to be rotated for the purpose.

Also to enhance the ease of operation, an accurate linear guide B-B perpendicular to the measuring direction of the height gauge can be integrated into the wedge probe, so that the wedge can be displaced from the lower thread into the upper thread over approximately half the pitch without requiring the height gauge to be displaced for that purpose.

Over against the advantage that the wedge probe measuring instrument as a one-dimensional instrument can be made of a simple and compact construction and that the percentage of the carrying proportion at different profile depths is known after measurement with different wedge widths, and that the measuring uncertainty is insensitive to deviations in the partial flank angles, there is the disadvantage that the geometry of the screw thread profile is not entirely known, as a consequence of which, in extreme situations, it cannot be made completely sure that internal and external screw threads which have been measured with a wedge probe exclusively one-dimensionally, will indeed fit. In various applications, this is not an objection. If it is an objection, however, the one-dimensional measurement of the screw thread can be supplemented with the method according to the invention with the two-dimensional wedge probe measurement as described in the following.

FIG. 23 illustrates schematically the method for determining the left-hand partial flank angle H1 and the right-hand partial flank angle H2 of a screw thread profile 97 with the aid of two fixed wedge probes of a wedge width B1 and B2 which are successively positioned in the profile. The horizontal distance X between the positions of the measuring sides A and F is measured, as well as the vertical distance Y.

Thus, the information is available for computing the left-hand and the right-hand partial flank angles:

H1=arctan(X/Y)

H2=arctan[(B1-B2-X)/Y]

If more than two measurements are carried out, it is possible, with known regression computation methods, also to determine the straightness of the left-hand and right-hand flank including the angles of the regression lines which are computed through the left-hand and right-hand flank.

By placing at least one of the wedge probe referred to in the next profile as well, and measuring the horizontal distance between these two probe positions, the pitch is measured as well (see FIG. 24).

FIG. 31 illustrates schematically an example according to the invention of a measuring device for determining the left-hand and right-hand flank angle, optionally the straightness of the flanks and the pitch.

Use is made of an instrument which consists of a support 94 on which an accurate horizontal linear guide with integrated electronic X displacement detector 95 is mounted. Mounted perpendicularly to 95 is an accurate vertical linear guide with integrated electronic Y displacement detector 92. Mounted on the thus formed X-Y measuring table is an electric drive 93 with angle encoder 96 having the output shaft 91 parallel to the X-axis.

The output shaft 91 passing through the drive unit will have a negligible axial and radial stroke during rotation.

The exchangeable wedge element 90 is mounted on the end of shaft 91, while the left-hand measuring side is formed by the circle which is formed by the intersection of a plane perpendicular to the centerline of shaft 91 and a right circular cylinder which is concentric with respect to the centerline of 91. The wedge element can have a suitable wedge width/setting angle characteristic in conformity with FIG. 26 or 27. For the purpose of measurement, the fixed support should be placed on the workpiece, such that the X-axis is disposed parallel to the centerline of the screw thread to be measured, whereafter it is locked against displacement during the measurement through a suitable clamp or magnet.

After the wedge element has been placed in the screw thread profile by the measuring technician, the wedge probe, due to its own weight or through a separate press-on force, induced, for instance, by a spring or a like element, will slide down to the deepest point of the screw thread profile 97.

Thereafter, the wedge element is rotated to the next wedge width by the drive unit.

With the rotary wedge probe, which probes at least two positions of the screw thread profile at a different profile depth, whilst the wedge width being in probing condition is set by measuring the wedge width/setting angle characteristic of the wedge element 90 and the rotation of the shaft 91 and the angular displacement WH.1 and WH.2 of the wedge probe shaft with the encoder 96 simultaneously with the displacements relative to the fixed support 94 in X direction: MX.1, MX.2 and Y direction: MY.1 and MY.2, the left-hand and right-hand partial flank angles can be identically computed:

H1=arctan[(MX.2−MX.1)/(MY.2−MY.1)]

H2=arctan[(B1−B2−MX.1+MX.2)/(MY.2−MY.1)]

The measuring device can be provided with a device for processing the measuring values of the angle encoder and the two linear measuring detectors.

Also, the measuring device may be provided with a communication device for the transmission, which may be wireless or not, of the measuring data of the angle encoder and the two linear measuring detectors and of the results of the processed measuring values in the case where the measuring device includes a processing device.

Although in the description the starting point has been screw thread, the invention can also be used for measuring other, similar grooves.

Further elucidation of the appended figures;

FIG. 1 schematically shows in longitudinal cross section an example of a workpiece provided with an external screw thread.

FIG. 2 schematically illustrates an example of a method according to the invention based on simultaneous wedge probe probing for determining a diameter dW of an imaginary cylinder whose centerline coincides with the centerline of the screw thread and whose circumferential surface intersects the screw thread in a manner such that the carrying proportion, being defined as the ratio between material and pitch, is equal to the ratio between the difference between the pitch p and the wedge width B on the one hand and the pitch p on the other.

FIG. 3 schematically illustrates a variant of the method in FIG. 2, where the wedge width B has a size exactly equal to half the pitch and half the nominal pitch, respectively, and the diameter M of the imaginary cylinder is therefore equal to the defined flank diameter and simple flank diameter d2, respectively.

FIG. 4 schematically illustrates a variant of the method in FIGS. 2 and 3, involving a complementary wedge probe which bridges the material instead of the air.

FIG. 5 schematically illustrates the known method of the rim and cone method in combination with a geometrically ideally shaped external screw thread, involving optimum contact surface between probes and flanks.

FIG. 6 schematically illustrates, as a variant of FIG. 2, an example of a method according to the invention based on sequential profile depth measurement, with wedge probe probing whereby the diameter dW is determined by measurement of the outside diameter M1 with a suitable instrument such as a sliding gauge or thread gauge and subsequently of the profile depth M2 with a wedge probe having a wedge width B on two diametrically opposite profiles.

FIG. 7 schematically illustrates, as a variant of FIGS. 3 and 6, an example of a method according to the invention based on sequential profile depth measurement with wedge probe probing whereby the flank diameter d2 is determined by measurement of the outside diameter M1 with a suitable instrument such as a sliding gauge or thread gauge and subsequently of the profile depth M2 with a wedge probe having a wedge width B equal to half the pitch on two diametrically opposite profiles.

FIG. 8 schematically illustrates a variant of FIGS. 4 and 7, whereby the flank diameter is determined by a sequential probing with a complementary wedge probe.

FIGS. 9 and 10 schematically illustrate an example of the method according to the invention for determining the flank diameter of strongly asymmetrical screw thread with wedge probes having a wedge probe width B which in equal to half the pitch.

FIG. 11 schematically illustrates the sensitivity of the known rim and cone method to variations of the partial flank angles through the comparison of three screw threads all having the same flank diameter d2 but each having a different flank angle, which is greater than, equal to and smaller than the flank angle for which the rim and cone probe is intended: each situation results in a different measuring value M+F1, M and M+F2.

FIG. 12 schematically illustrates the insensitivity of the method according to the invention to variations of the partial lank angles through the comparison of the same three screw threads from FIG. 11, which all have the same flank diameter d2 but each have a different flank angle which is greater than, equal to and smaller than the nominal flank angle: each situation results in the same measuring value M.

FIG. 13 schematically shows a cross section and an elevation of a wedge probe of variable wedge width according to the invention.

FIG. 14 schematically shows a measuring device according to the invention for measuring internal screw thread, consisting of an internal thread gauge with analog or electronic measuring system and adapters 31 and 32 with two wedge probes 33 for simultaneously probing the internal screw thread 30.

FIG. 15 schematically shows a measuring device according to the invention for measuring external screw thread, consisting of a sliding gauge with analog or electronic measuring system and adapters 34 with two wedge probes 33 for simultaneously probing the external screw thread.

FIG. 16 schematically shows the determination of the zero point of a measuring device according to FIG. 15.

FIG. 17 schematically shows the measurement of an external screw thread with a measuring device according to FIG. 15.

FIG. 18 schematically shows an example of a measuring device according to the invention for measuring internal screw thread, consisting of a sliding gauge with analog or electronic measuring system and two adapters with two wedge probes for simultaneously probing of the external screw thread.

FIG. 19 schematically shows, by way of example, in elevation and partial cross section, a measuring device according to the invention for measuring external screw thread, consisting of a support with a centering aid, a clock gauge with an analog or electronic measuring system and a wedge probe for sequentially probing the external screw thread, with the wedge probe rotated through 90° to be supported on the outside diameter for the zero point determination.

FIG. 20 schematically shows in elevation and partial cross section a measuring device according to FIG. 19, with the wedge probe being supported in the profile for determining the profile depth.

FIG. 21 schematically shows, by way of example, the partial cross section of a measuring device according to the invention for measuring external screw thread, consisting of a sliding gauge with analog or electronic measuring system and two wedge probes of which one wedge probe is of the complementary type for simultaneously probing external screw thread.

FIG. 22 shows a detail of FIG. 21.

FIG. 23 schematically illustrates the method according to the invention for determining the left-hand partial flank angle H1 and the right-hand partial flank angle H2 of a screw thread profile by means of two profile depth measurements with different wedge probe widths B1 and B2.

FIG. 24 schematically shows an example of a measuring device according to the invention for measuring external screw thread, consisting of a sliding gauge with an analog or electronic measuring system, centering aid 102 and two wedge probes 33 for simultaneously probing the external screw thread, having the characteristic that the linear measuring system 101 is placed in line with the diameter to be measured, so that the well-known ABBE error is eliminated.

FIG. 25 schematically illustrates the method according to the invention for determining the pitch p of a screw thread profile by means of two profile depth measurements with two equal wedge probe widths in two successive profiles.

FIG. 26 schematically shows, as an example according to the invention, a wedge probe of variable wedge width, based on a probe adjustable about a rotary shaft, having a wedge width/setting angle characteristic over twice 180° with a scale division for setting the wedge width on the basis of the pitch in mm over 180° and the number of threads per inch over the other 180°.

FIG. 27 schematically shows, as an example according to the invention, a wedge probe of variable wedge width, based on a probe adjustable about a rotary shaft, having a wedge width/setting angle characteristic over 360° with a scale division for setting the wedge width on the basis of the pitch in mm or the number of threads per inch over 360°.

FIG. 28 schematically shows, as an example according to the invention, a variable wedge probe with mount for a coordinate measuring machine or height gauge, based on a probe adjustable about a shaft, having a wedge width/setting angle characteristic which repeats itself after 180°, so that at two opposite positions of the wedge probe an equal wedge width can be set.

FIGS. 29 and 30 schematically show an example of a measuring device according to the invention for measuring screw thread, consisting of a height gauge on flat plate or coordinate measuring machine with analog or electronic measuring system and a wedge probe of fixed or variable wedge width according to FIG. 28, which is suitable or two-sided probing, at the top and at the bottom, for sequentially probing the screw thread and which can optionally rotate, for promoting the ease of operation, about the vertical axis A-A and is linearly displaceable by means of a linear guide B-B.

FIG. 31 schematically illustrates an example according to the invention of a measuring device or determining the left-hand and right-hand flank angle, optionally the straightness of the flanks and the pitch by means of a rotary wedge probe, which probes at least two positions of the screw thread profile, while the wedge width being in probing condition is determined by measuring, for instance, the wedge width/setting angle characteristic and the measurement of angular displacement WH.1, WH.2 of the wedge probe shaft simultaneously with the linear displacements relative to the fixed support in the X direction: MX.1, MX.2 and Y direction: MY.1 and MY.2.

In the following, advantageous embodiments of the invention are described.

Method for determining one or more geometric parameters of an axial cross section of internal or external screw thread, characterized in that two screw thread profiles which are diametrically opposite each other and which are both situated in a plane through the centerline of the screw thread, are mechanically probed simultaneously or sequentially in radial direction with wedge probes which have a fixed or variable wedge width, and that the distance in radial direction between the probing positions of the wedge probes is measured directly in the case of simultaneous measurement, or in the case of sequential measurement is determined indirectly by linked measurement with at least one suitable intermediate parameter such as, for instance, the outside diameter in the case of external screw thread and the core diameter in the case of internal screw thread, and wherein further the pitch of the screw thread profile is known through separate measurement or else is assumed to be nominal.

Method for determining one or more geometric parameters of an axial cross section of internal or external screw thread profiles such as the left-hand and right-hand partial flank angle, the straightness of the left-hand and right-hand profile flank and the pitch, characterized in that a screw thread profile in a plane through the centerline of the screw thread is sequentially mechanically probed in radial direction by at least two wedge probes of different and known wedge width or one variably adjustable wedge probe having at least two different and known wedge width settings and that in axial and in radial direction the relative probing positions of the wedge probes are measured.

Method for determining diameters in a thread of internal or external screw thread with a particular ratio between material and air, which is represented by the ratio of the difference between the rise or pitch and the wedge width on the one hand and the wedge width on the other, characterized in that in each of the two profiles simultaneously or successively a wedge probe is placed in radial direction, which is so shaped that the wedge probe is supported exclusively on the left-hand flank and the right-hand flank of the screw thread with the two sharp measuring sides of the wedge, which at the location of the axial screw thread plane has a known wedge width, being the distance between the two measuring sides, whose magnitude is a percentage, to be selected, of the pitch, which has priorly been determined separately, or is assumed to be nominal, whereafter directly or indirectly in the diametrical direction of the screw thread the distance between the two wedge probe positions constitutes a representation of the diameter of a cylinder surface, concentric with respect to the screw thread reference axis, that intersects the screw thread profiles at the point with the supporting proportion referred to.

Method or determining the flank diameter in a thread of internal or external screw thread, characterized in that the set wedge width is equal to half the rise or pitch, so that the diametrical distance between the wedge probes, which is measured directly or indirectly, is equal to the diameter of the concentric cylinder surface which intersects the screw thread at a position with 50% material and 50% air.

Method for determining the flank diameter in a thread of internal or external screw thread, characterized in that the set wedge width is equal to half the nominal rise or nominal pitch, so that the diametrical distance between the wedge probes, which is measured directly or indirectly, is equal to the diameter of the concentric cylinder surface which intersects the screw thread at a position where the segment surface lines of the cylinder surface in the groove have a length equal to half the nominal pitch.

Method for determining the flank diameter in a thread of internal or external screw thread, characterized in that only at one point of the screw thread the depth of the wedge probe in the profile, the distance between the profile top and the depth with 50% carrying proportion, is measured, that it is assumed that the workpiece is manufactured concentrically to such an extent that the profile situated diametrically opposite the selected point has a substantially identical shape, whereafter the flank diameter is computed by twice adding the profile depth associated with 50% carrying proportion to the core diameter in the case of internal thread and in the case of external thread to subtract this profile depth twice from the outside diameter.

A method for determining the simple flank diameter in a thread of internal or external screw thread, characterized in that only at one point of the screw thread the depth of the wedge probe in the profile, the distance between the profile top and the depth of the groove where the segment length of the concentric cylinder surface line is equal to 50% of the nominal pitch, is measured, that it is assumed that the workpiece is manufactured concentrically to such an extent that the profile situated diametrically opposite the selected point has a substantially identical shape, whereafter the flank diameter is computed by adding this profile depth twice to the core diameter in the case of internal thread and in the case of external thread to subtract this profile depth twice from the outside diameter.

A probe for probing an internal or external screw thread profile in radial direction, having a fixed wedge width, provided with a mounting pivot around which the probe can pivot freely in the mounting bore of the probe in a one-dimensional measuring device and two sharp measuring sides with which the profile is probed and which, at the probing points on the screw thread profile, are situated in a plane perpendicular to the centerline of the mounting pivot and which further are mutually parallel and are situated symmetrically with respect to the centerline through the mounting pivot and there have a known mutual distance, the wedge width, while the probe body further is shaped such that probing engagement with the screw thread profile occurs exclusively on the two measuring sides of the probe at a plane through the centerline of the mounting pivot and on the left-hand and right-hand flank and thus bridges the air in the groove of the screw thread.

Probe for probing an internal or external screw thread profile in radial direction, having a fixed wedge width of the complementary type, provided with a mounting pivot around which the probe can pivot freely in the mounting bore for the probe in a one-dimensional measuring device and two sharp measuring sides with which the profile is probed and which, at the probing points on the screw thread profile, are situated in a plane perpendicular to the centerline of the mounting pivot and which, further, are mutually parallel and are situated symmetrically with respect to the centerline through the mounting pivot and there have a known mutual distance, while the probe body further is shaped as a fork, that probing engagement with the screw thread profile takes place exclusively on the two measuring sides of the probe at a plane through the centerline of the mounting pivot and on the left-hand and right-hand flank and thus reaches over the top of the screw thread profile.

Probe as described hereinbefore, with the characterizing difference that one of the two measuring sides, at the probing point on the screw thread profile, is farther situated in a plane through the centerline of the mounting pivot and therefore intersects this centerline.

Probe for probing an internal or external screw thread profile in radial direction, having a variably adjustable wedge width, provided with a mounting pivot around which the probe can pivot freely in the mounting adapter of the probe in a one-dimensional measuring device and a wedge element having two sharp measuring sides with which the profile is probed and which, at the probing points on the screw thread profile, are situated in a plane perpendicular to the centerline of the mounting pivot and which have a known adjustable mutual distance, which can be read with an indication scale on the basis of the screw thread pitch in millimeters and/or threads per inch and whose setting can be fixed, while one of the two measuring sides in each case is situated in one plane with the centerline of the mounting pivot and the probe body, further, is shaped such that probing engagement with the screw thread profile takes place exclusively on the two measuring sides of the probe adjacent a plane through the centerline of the mounting pivot and on the left-hand and right-hand flank and thus bridges the air in the groove of the screw thread.

Probe as described hereinbefore, wherein the wedge width is set continuously variably or incrementally, by rotating the wedge probe element with a pivot in a bore of the probe housing through a setting angle which after setting is fixed by means of a clamping screw while the axial play is eliminated by means of a spring ring.

Probe as described hereinbefore, wherein the set wedge width is represented on a scale division which has been calibrated in pitch which is indicated on the scale in millimeters or threads per inch.

Probe as described hereinbefore, wherein the wedge element can be used on two opposite sides for probing a screw thread profile, and the two probing locations both have the same wedge width and both are situated in a line which is parallel with respect to the one-dimensional measuring system to be used.

Probe as described hereinbefore, wherein the probe housing is provided with a freely pivoting hinge which is disposed parallel with respect to the measuring axis of the one-dimensional measuring system to be combined with the probe.

Probe as described hereinbefore, wherein the probe housing is provided with a linear guide which is disposed perpendicularly to the measuring axis of the one-dimensional measuring system to be combined with the probe.

Detachable or incorporable probe mounts for combining probes as described hereinbefore with known and already available instruments such as sliding gauges, thread gauges, clock gauges, height gauges, coordinate measuring machines and universal single-axial measuring machines.

A measuring device for determining the left-hand and right-hand flank angle, optionally the straightness of the flanks and the pitch of a screw thread profile, provided with a support having mounted thereon an X-Y table with a rotatable pivot an which a fixed or exchangeable wedge element is mounted, further comprising detection means for measuring the displacement in X- and Y-direction and the setting angle of the wedge element.

A measuring device as described hereinbefore, wherein the rotatable pivot for setting the proper wedge width is rotated by means of an electric drive.

A measuring device as described hereinbefore, wherein the instrument with the support is placed on the workpiece and is fixed with a clamp or a magnet, so that the X-axis is parallel to the centerline and the Y-axis of the X-Y table are disposed as best as possible through the centerline of the screw thread to be measured, optionally through the addition of extra adjusting means.

A measuring device as described hereinbefore, wherein the probing force between wedge element and the screw thread profile is provided by its own weight or, supplemental thereto, a separate press-on force with a spring or a like element.

A measuring device as described hereinbefore, wherein the detection means are provided with a communication device, which may or may not be wireless, for transmission of the measuring data to an external processing unit.

A measuring device as described hereinbefore, wherein the detection means are connected with a processing unit for computing the desired screw thread parameters with subsequent presentation on a display or transmission by a communication device which may or may not be wireless.

1. A method for determining a geometric parameter of an axial cross section of internal or external screw thread, comprising
with at least one probe, mechanically probing in radial direction two screw thread profiles of the screw thread to be measured, at two probing positions located diametrically opposite each other and both situated in a plane through a centerline of the screw thread,
measuring a distance in said plane through the centerline of the screw thread in radial direction with respect to the screw thread between the probes in probing position, characterized in that
the at least one probe is a wedge probe, further comprising the setting of a probing width of the at least one wedge probe,
determining the geometric parameter on the basis of the measured distance between the probes in probing position and a pitch of the screw thread.

2. A method according to claim 1, characterized by sequentially probing the screw thread at the two probing positions.

3. A method according to any one of the preceding claims, comprising determining the geometric parameter on the basis of the measured distance between wedge probes in probing position and a nominal pitch of the screw thread.

4. A method according to claim 1 or 2, further comprising
measuring a distance in a plane through the centerline of the screw thread in axial direction with respect to the screw thread between the wedge probes in probing position, while a probing width of the at least one wedge probe is mutually different per probing position,
and
determining a pitch of the screw thread on the basis of the measured axial distance between the wedge probes in probing position.

5. A method according to any one of the preceding claims, wherein two wedge probes are used.

6. A method according to any one of claims 1-5, further comprising
setting the probing width by setting a distance between a first and a second probing side of the wedge probe of the probing position of the wedge probe, and
probing the screw thread profile at the respective probing position by placing the first probing side an a left-hand flank of the screw thread and placing the second probing side on a right-hand flank of the screw thread.

7. A method according to any one of claim 1-6, further comprising
setting a probing width which is equal to a predetermined percentage of the pitch of the screw thread.

8. A method according to claim 7, wherein the predetermined percentage is 50% of the nominal pitch or 50% of the actual pitch of the screw thread.

9. A method for determining a flank diameter, or a simple flank diameter, respectively, of an axial cross section of internal or external screw thread, characterized by mechanically probing a screw thread profile in radial direction in a plane through the centerline of the screw thread with at least one wedge probe,
measuring a distance in radial sense with respect to the screw thread between the probing position of the wedge probe and a profile top of the screw thread, and
determining a flank diameter on the basis of the measured radial distance and a core diameter of the screw thread in the case of internal thread and an outside diameter in the case of external thread.

10. A method according to claim 9, wherein the probing width of the wedge probe is 50% of the actual pitch or 50% of the nominal pitch of the screw thread, respectively.

11. A device for probing an internal or external screw thread profile, comprising
a first probing element,
a second probing element, and
a measuring device for determining the relative distance in measuring condition between the probing elements in a measuring plane, while each probing element is provided with a probe with two probing sides spaced apart a probing width, further comprising positioning means for positioning the probing elements such that lines through the respective probing sides of each probing element are oriented mutually parallel and are oriented, perpendicularly with respect to the measuring plane.

12. A device according to claim 11, wherein the positioning means are so designed that the probing elements are rotatable about a pivot having a centerline situated in the measuring plane.

13. A device according to claim 11 or 12, wherein at least one of the probing elements is provided with setting means for setting a probing width.

14. A device according to claim 13, wherein the at least one probing element is provided with a beveled cylindrical disc with a flat side and a beveled side, while the flat side is located parallel to the measuring plane, which disc is mounted on the probing element so as to be rotatable about an axial body axis.

15. A device according to any one of claims 11-14, wherein the probing sides of at least one probe element are mounted on a fork structure.

16. A device according to any one of claims 11-15, wherein the measuring device is provided with a processing device arranged for determining geometric parameters at least on the basis of measuring results obtained with the measuring device.

17. A probing element for use in a device according to claim 14, comprising a frame, a measuring disc provided with a top surface with a first circumferential edge, and a bottom surface with a second circumferential edge, the measuring disc being mounted on the frame so as to be rotatable about an axial body axis, while the first circumferential edge forms a first probing edge and a second circumferential edge forms a second probing edge, while the distance between the first and second circumferential edge at the edge of the measuring disc in axial direction is different at least two positions on the edge of the measuring disc.

18. A probing element according to claim 17, wherein the bottom surface of the measuring disc is a straight surface which is perpendicular with respect to the axial body axis of the measuring disc.

19. A probing element according to claim 18, wherein the top surface of the measuring disc is a straight surface which is at a constant angle with respect to the axial body axis of the measuring disc.

20. A probing element according to claim 17 or 18, wherein the top surface of the measuring disc has a mirror-symmetrical topography with respect to a plane through the axial body axis of the measuring disc.

21. A probing element according to any one claims 17-20, provided with an analog or digital scale division.

22. A measuring disc for use in a probe according to any one of claims 17-21.
